(19) United States
(12) Patent Application Publication
(10) Pub. No.: US 2026/0182578 A1
(43) Pub. Date: Jul. 2, 2026

(54) ETHANOL FEEDSTOCK MICROBIOLOGICAL CONTROL

(71) Applicant: ECOLAB USA INC., St. Paul, MN (US)

(72) Inventors: Matthew Albert Bilski, New Brighton, MN (US); Brian Lawrence Sholes, North Saint Paul, MN (US); Richard Joseph Walsh, Woodbury, MN (US); Teresa Podtburg, Waconia, MN (US)

(21) Appl. No.: 19/426,969

(22) Filed: Dec. 19, 2025

Related U.S. Application Data
(60) Provisional application No. 63/739,811, filed on Dec. 30, 2024.

(51) Int. Cl. A01N 59/00; A01N 25/12; A01P 1/00

(52) U.S. Cl. CPC A01N 59/00; A01N 25/12; A01P 1/00

(57) ABSTRACT

Compositions and methods for reducing microbial population on the surface of whole raw materials to be used in ethanol production. Whole raw materials to be used in ethanol production may have surface contamination with microbial populations that can interfere with the ethanol production process. The compositions comprise one or more antimicrobials capable of reducing microbial population when applied to the surface of the whole raw material.

### CROSS REFERENCE TO RELATED APPLICATION

This application claims priority from U.S. Application Ser. No. 63/739,811, filed Dec. 30, 2024, the disclosure of which is incorporated herein by reference.

### BACKGROUND

Microbial overgrowth in ethanol production poses significant challenges. A common problem in ethanol production is the proliferation of unwanted microorganisms that are not part of the intended fermentation process. These microorganisms can contaminate various parts of the fermentation process, leading to competition for nutrients, reduced ethanol yields, and increased production costs. The contamination can also negatively impact the quality of the final ethanol product, making it unsuitable for its intended applications. It is against this background that the present disclosure is made.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

Disclosed herein is a method of reducing a microbial population on a whole raw material for ethanol production, the method comprising: applying a composition to the whole raw material, the composition comprising one or more antimicrobials, wherein the composition is free of solvent or alcohol.

Also disclosed herein is a method of reducing a microbial population on a whole raw material for ethanol production, the method comprising: applying a dry powdered composition to the whole raw material, the composition comprising a peracetic acid-forming mixture comprising TAED, percarbonate, carbonate, and an acidifying agent; mixing the dry powdered composition and the whole raw material to form a coated whole raw material; and exposing the coated whole raw material to atmospheric conditions for a period of time, wherein the composition is free of solvent or alcohol.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 depicts a schematic diagram of an example fermentation system.

### DETAILED DESCRIPTION

As used herein, weight percent (wt. %), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the disclosure or employed in the methods of the disclosure refers to variation in the numerical quantity that can occur, for example, through typical measuring and liquid handling procedures used for making use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities. The term “about” typically allows for a variation within ±5% of the stated percent value. For example, if “about 10%” is used, the term “about” typically allows for a variation of about 5% of the stated percent value, 10%. Thus, “about 10%” may cover a variation of ±0.5%.

As used herein, the terms “substantially free,” “substantially free of,” and “free of” of a particular substance means that the compositions of the instant specification contain less than 0.5 wt. % of the recited substance. When referring to “substantially free,” “substantially free of,” and “free of” it is intended that the substance is not intentionally added to the compositions. The term “essentially free” of a particular substance means that the compositions of the instant specification contain less than 0.1 wt. % of the recited substance. When referring to “essentially free” it is intended that the substance is not intentionally added to the compositions. The term “essentially completely free” of a particular substance means that the compositions of the instant specification contain less than 0.01 wt. % of the recited substance. When referring to “essentially completely free” it is intended that the substance is not intentionally added to the compositions. The term “completely free” of a particular substance means that the compositions of the instant specification contain less than 0.001 wt. % of the recited substance. When referring to “completely free” it is intended that the substance is not intentionally added to the compositions. Use of the term “completely free” allows for trace amounts of that substance to be included in compositions because they are present in another substance in the composition. However, it is recognized that only trace or de minimus amounts of a substance will be allowed when the composition is said to be “completely free” of that substance.

As used herein, the term “consisting essentially of” in reference to a composition refers to the listed ingredients and does not include additional ingredients that, if present, would affect the microbial reduction ability of the composition. The term “consisting essentially of” may also refer to a component of the composition. For instance, a composition for reducing microbial population may consist essentially of one antimicrobial agent or antimicrobial precursor and would not include any other ingredients that would affect the effectiveness of the antimicrobial agent- or antimicrobial precursor-containing composition. As used herein, the term “consisting essentially of” in reference to a method of reducing microbial population refers to the listed steps and does not include additional steps (or ingredients if a composition is included in the method) that, if present, would affect the microbial reduction ability of the method.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

As used herein, the phrase “whole raw material” refers to a natural or naturally derived product comprising sugars or cellulose that can be converted to ethanol and the natural or naturally derived product has not undergone significant processing. Significant processing refers to processing that changes the state of the raw material, such as by grinding or milling or crushing to change the whole raw material to a ground, semi-ground, or crushed form. A whole raw material may undergo some processing, such as removing husks, shells, stalks, or other components of the raw material that would not be used during ethanol production. For example, a whole raw material as described herein can refer to whole kernels of corn that have been removed from the stalks and other components of the corn plant (e.g., cob, leaves, husks, tassels, silk), but the corn kernels have not changed shape (i.e., have not been ground or milled or crushed). Other examples of whole raw materials include rice, nuts, wheat berries, sugar cane, sugar beets, corn stover (e.g., stalks, leaves, husks, cobs), switch grass, miscanthus, other perennial grasses, wheat straw, forestry waste (e.g., wood chips, sawdust, tree tops, branches), paper waste, or other high-carbohydrate feed sources that have been removed from the plant, with husks and other outer coverings removed, and possibly cut into smaller pieces (e.g., billets), but have not been ground or milled or crushed.

Ethanol production converts a raw material, such as corn, or other high-carbohydrate material, into ethanol. The process typically begins with grinding or milling the raw material to release fermentable sugars, followed by fermentation, where yeast converts these sugars into ethanol and carbon dioxide. After fermentation, the mixture may be distilled to separate the ethanol from other components, resulting in a high-purity alcohol. The byproducts of this process, such as spent grains, can be utilized for animal feed, enhancing overall resource efficiency.

In one example of an ethanol production system, a whole raw material is brought to a facility on a truck or other mode of transportation. The whole raw material may comprise corn, rice, nuts, wheat berries, sugar cane, sugar beets, other high-carbohydrate feed sources, and combinations thereof. The whole raw material is often placed into hoppers and transferred to silos for storage, where the whole raw material may sit for days before being used for ethanol production.

When the whole raw material arrives at an ethanol production facility, it often has been taken directly from farms or other agriculture sites where the raw material was harvested. Typically, there has been no cleaning or disinfecting of the raw material, and thus the raw material may be contaminated with soil and bacteria. Common types of bacteria that may contaminate raw material are lactic acid- and acetic acid-producing bacteria.

Lactic acid- and acetic acid-producing bacteria pose threats to ethanol production as the bacteria can compete with the yeast and may use the raw material as a food source. If left unchecked, bacteria in the ethanol fermentation process can lead to formation of unwanted byproducts, lower fermentation efficiency because the bacteria consumes sugars in the raw material, and potential issues with spoilage of the raw material or intermediate products of the ethanol production.

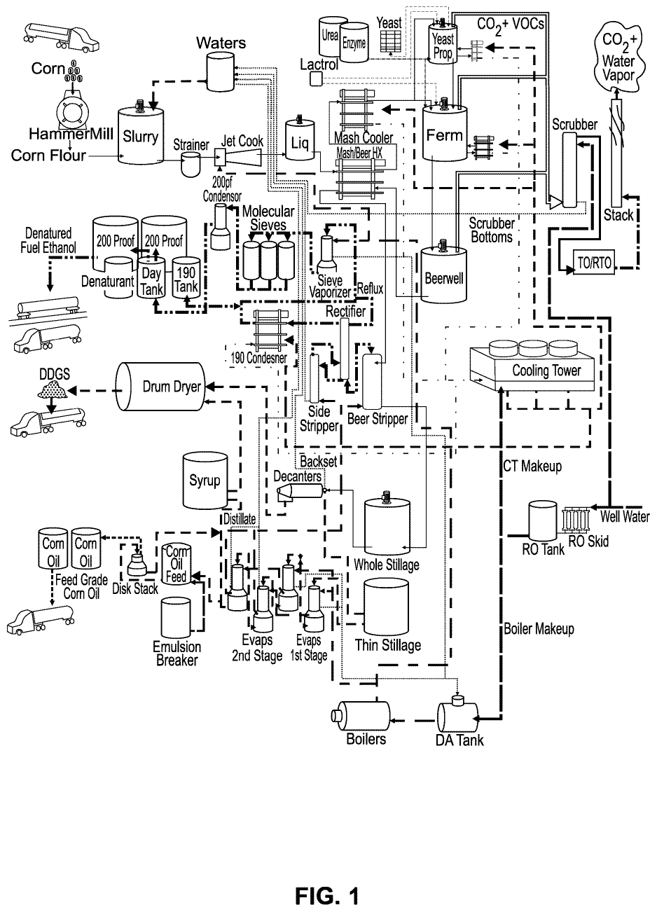

Before the ethanol production process begins, bacteria may remain on the surface of the raw material. When the raw material is ground or milled or crushed, the bacteria remains and the milled product with the bacteria is added to the ethanol production system. When bacteria is introduced into the ethanol production system in this manner, it can proliferate through various stages of the ethanol production process. An example ethanol production system is shown in FIG. 1. When bacteria on the surface of the raw material enters the ethanol production process, the bacteria can proliferate in many, if not all, of the stages of ethanol production shown in FIG. 1.

Conventional solutions to address bacterial overgrowth of microorganisms in ethanol production often rely on the use of antibiotics. However, public concern regarding antibiotic resistance and sustainability has made antibiotics a less favorable option for controlling bacterial overgrowth.

Additionally, industrial fermentation operations for making ethanol are constrained by strict standards for waste disposal. For example, most biofuel fermentation operations are not permitted to send any waste to the drain, and therefore the only way for material to leave an ethanol production plant is through steam, product streams (e.g., ethanol), or by-product streams (e.g., fermentation solids that are converted into another product such as animal feed, corn oil, or syrup). The by-product streams of ethanol production almost always must be Generally Recognized As Safe (“GRAS”) under US Food and Drug Administration guidelines in order to be used as food products for humans or animals.

Controlling microbial overgrowth in ethanol production without the use of antibiotics, while using GRAS components, poses significant challenges to the industry.

The present disclosure addresses these concerns by using compositions and methods to control microbial populations in ethanol production. In some examples, a composition is added to the raw material when it is in its whole form.

The whole raw material may comprise a material suitable for use in ethanol production. The whole raw material may comprise corn, rice, nuts, wheat berries, sugar cane, sugar beets, other high-carbohydrate feed sources, and combinations thereof.

The present disclosure contemplates use in fermentation systems for production of carbohydrate ethanol, cellulosic ethanol, or combinations thereof.

Carbohydrate ethanol, often called starch- or sugar-based ethanol, is made from plant materials that already contain readily accessible carbohydrates. Common feedstock used for carbohydrate ethanol include corn, sugarcane, sugar beets, and other high-starch or high-sugar crops, such as those described herein. In this process, the carbohydrates are converted by breaking down starches into simple sugars, which are then fermented by yeast to produce ethanol.

Cellulosic ethanol is made from cellulose. Cellulose is the tough, fibrous material that makes up the cell walls of plants. Cellulose for fermentation is derived from non-edible biomass including but not limited to corn stover (e.g., stalks, leaves, husks, cobs), switch grass, miscanthus, other perennial grasses, wheat straw, forestry waste (e.g., wood chips, sawdust, tree tops, branches), or paper waste. Because cellulose is difficult for enzymes to break down, production involves pretreatment to open the fibers, enzymatic hydrolysis to release sugars, and fermentation to convert those sugars into ethanol.

In some examples, the present disclosure is directed to reducing and/or controlling microbial populations in carbohydrate ethanol production. In some examples, the present disclosure is only used in carbohydrate ethanol production. In some examples, the present disclosure is not used in carbohydrate ethanol production.

In some examples, the present disclosure is directed to reducing and/or controlling microbial populations in cellulosic ethanol production. In some examples, the present disclosure is only used in cellulosic ethanol production. In some examples, the present disclosure is not used in cellulosic ethanol production.

### Compositions for Use in Microbiological Control

The compositions described herein may comprise one or more antimicrobial agents or antimicrobial precursors and one or more functional agents. The one or more antimicrobial agents or antimicrobial precursors may comprise individual antimicrobials that, on their own, exhibit antimicrobial activity. The one or more antimicrobial agents or antimicrobial precursors may also be derived from multiple components that, when added together, act as or form antimicrobials.

As used herein, “antimicrobial precursor” refers to components that, on their own, do not exhibit antimicrobial activity (or exhibit minimal antimicrobial activity) but when combined with other components, such as other antimicrobial precursors, form antimicrobial agents.

The compositions may be formed by combining the one or more antimicrobial agents or antimicrobial precursors with the one or more functional agents prior to application to the whole raw material. The compositions may also be formed by applying the one or more antimicrobial agents or antimicrobial precursors and the one or more functional agents separately to the whole raw material and mixing to combine. In such examples, the composition is formed while in contact with the whole raw material.

The one or more antimicrobial agents or antimicrobial precursors act on the surface of the raw material to reduce the microbial population on the surface of the raw material. The one or more antimicrobial agents or antimicrobial precursors may be specific for acetic acid-producing bacteria, lactic acid-producing bacteria, gram negative bacteria, gram positive bacteria, or combinations thereof.

In some examples, the one or more antimicrobial agents or antimicrobial precursors comprise tetraacetylethylenediamine (TAED), peracetic acid, ozone, chlorine dioxide, nisin, sodium chlorite, hydrogen peroxide, acetic acid, sodium hypochlorite, organic acids, percarbonate, carbonate, and combinations thereof. The compositions described herein may comprise a single antimicrobial agent or antimicrobial precursor, or a combination of antimicrobial agents or antimicrobial precursors.

In some examples, the composition further comprises one or more functional agents including but not limited to surfactants, polymers, binders, fillers, anti-caking agents, desiccating agents, stabilizers, preservatives, chelating agents, sequestrants, and combinations thereof.

In some examples, the composition further comprises one or more solid carriers selected from the group consisting of sugar, starch, sodium bicarbonate, cellulose, urea, maltose, yeast extract, sodium sulfate, calcium sulfate, limestone, clay, diatomaceous earth, and combinations thereof.

In some examples, the composition may comprise about 0.1 ppm to about 50 ppm of the one of more antimicrobial agents or antimicrobial precursors. In some examples, the composition may comprise about 0.1 ppm to about 45 ppm, about 0.1 ppm to about 40 ppm, about 0.1 ppm to about 35 ppm, about 0.1 ppm to about 30 ppm, about 0.1 ppm to about 25 ppm, about 0.1 ppm to about 20 ppm, about 0.1 ppm to about 15 ppm, about 0.1 ppm to about 10 ppm, about 0.1 ppm to about 9 ppm, about 0.1 ppm to about 8 ppm, about 0.1 ppm to about 7 ppm, about 0.1 ppm to about 6 ppm, about 0.1 ppm to about 5 ppm, about 0.1 ppm to about 4 ppm, about 0.1 ppm to about 3 ppm, about 0.1 ppm to about 2 ppm, about 0.1 ppm to about 1 ppm, about 0.1 ppm to about 0.5 ppm, about 0.5 ppm to about 50 ppm, about 1 ppm to about 50 ppm, about 2 ppm to about 50 ppm, about 3 ppm to about 50 ppm, about 4 ppm to about 50 ppm, about 5 ppm to about 50 ppm, about 6 ppm to about 50 ppm, about 7 ppm to about 50 ppm, about 8 ppm to about 50 ppm, about 9 ppm to about 50 ppm, about 10 ppm to about 50 ppm, about 15 ppm to about 50 ppm, about 20 ppm to about 50 ppm, about 25 ppm to about 50 ppm, about 30 ppm to about 50 ppm, about 35 ppm to about 50 ppm, about 40 ppm to about 50 ppm, or about 45 ppm to about 50 ppm of one or more antimicrobial agents or antimicrobial precursors.

In examples where the composition comprises more than one antimicrobial agent or antimicrobial precursor, each antimicrobial agent or antimicrobial precursor may be present in the composition in a concentration of about 0.1 ppm to about 50 ppm. In some examples, the composition may comprise about 0.1 ppm to about 45 ppm, about 0.1 ppm to about 40 ppm, about 0.1 ppm to about 35 ppm, about 0.1 ppm to about 30 ppm, about 0.1 ppm to about 25 ppm, about 0.1 ppm to about 20 ppm, about 0.1 ppm to about 15 ppm, about 0.1 ppm to about 10 ppm, about 0.1 ppm to about 9 ppm, about 0.1 ppm to about 8 ppm, about 0.1 ppm to about 7 ppm, about 0.1 ppm to about 6 ppm, about 0.1 ppm to about 5 ppm, about 0.1 ppm to about 4 ppm, about 0.1 ppm to about 3 ppm, about 0.1 ppm to about 2 ppm, about 0.1 ppm to about 1 ppm, about 0.1 ppm to about 0.5 ppm, about 0.5 ppm to about 50 ppm, about 1 ppm to about 50 ppm, about 2 ppm to about 50 ppm, about 3 ppm to about 50 ppm, about 4 ppm to about 50 ppm, about 5 ppm to about 50 ppm, about 6 ppm to about 50 ppm, about 7 ppm to about 50 ppm, about 8 ppm to about 50 ppm, about 9 ppm to about 50 ppm, about 10 ppm to about 50 ppm, about 15 ppm to about 50 ppm, about 20 ppm to about 50 ppm, about 25 ppm to about 50 ppm, about 30 ppm to about 50 ppm, about 35 ppm to about 50 ppm, about 40 ppm to about 50 ppm, or about 45 ppm to about 50 ppm of each antimicrobial agent or antimicrobial precursor in the composition.

In examples where peracetic acid is used as an antimicrobial agent, the peracetic acid may be formed from the reaction between tetraacetylethylenediamine (TAED), percarbonate and/or carbonate, and an acidifying agent. As used herein, the combination of TAED, percarbonate and/or carbonate, and the acidifying agent is referred to as a peracetic acid-forming mixture. As described herein, the concentrations of TAED, percarbonate and/or carbonate, and the acidifying agent are described with respect to the peracetic acid-forming mixture unless otherwise specified.

Without wishing to be bound by theory, it is believed that the peracetic acid-forming mixture does not form peracetic acid until the peracetic acid-forming mixture is exposed to atmospheric conditions. The peracetic acid-forming mixture is formulated as a dry powder that remains stable and does not form peracetic acid until certain conditions are present. When the peracetic acid-forming mixture is exposed to atmospheric conditions (i.e., conditions that have moisture in the air), the components of the mixture interact with the moisture in the atmosphere and induce a reaction to form peracetic acid.

When TAED, percarbonate and/or carbonate, and an acidifying agent are combined together under atmospheric conditions, percarbonate reacts with TAED to generate two peracetate leaving groups per mole of TAED. The peracetate is then protonated by the acidifying agent to form peracetic acid. Therefore, the combination of TAED, percarbonate and/or and an acidifying agent creates the antimicrobial agent peracetic acid.

The acidifying agent may comprise citric acid, 2-hydroxypropane-1,2,3-tricarboxylic acid, sodium bisulfate, tartaric acid, malic acid, fumaric acid, formic acid, or combinations thereof. The acidifying agent may be a monoprotic, diprotic, or triprotic acid or salt thereof. The presence of the acidifying agent in combination with the TAED, percarbonate and/or carbonate results in a basic pH that allows for the peracetate to be protonated to form peracetic acid.

In some examples, the acidifying agent is solid. Exemplary acidifying agents that are available as solids include short chain carboxylic acids, such as acetic acid, lactic acid, propionic acid, butyric acid, valeric acid, caproic acid, and combinations thereof.

In some examples, when peracetic acid is used as the antimicrobial and is formed from the combination of TAED, percarbonate, carbonate, and an acidifying agent, the pH of the peracetic acid-forming mixture is about 8 to about 14, about 9 to about 14, about 10 to about 14, about 11 to about 14, about 12 to about 14, about 13 to about 14, about 8 to about 13, about 8 to about 12, about 8 to about 11, about 8 to about 10, or about 8 to about 9.

In such peracetic acid-forming mixture, TAED may be used in an amount of about 0.5 wt. % to about 30 wt. % of the peracetic acid-forming mixture. The peracetic acid-forming mixture may comprise TAED in an amount of about 0.5 wt. % to about 25 wt. %, about 0.5 wt. % to about 20 wt. %, about 0.5 wt. % to about 15 wt. %, about 0.5 wt. % to about 10 wt. %, about 0.5 wt. % to about 8 wt. %, about 0.5 wt. % to about 5 wt. %, about 0.5 wt. % to about 4 wt. %, about 0.5 wt. % to about 3 wt. %, about 0.5 wt. % to about 2 wt. %, about 0.5 wt. % to about 1 wt. %, about 1 wt. % to about 30 wt. %, about 2 wt. % to about 30 wt. %, about 3 wt. % to about 30 wt. %, about 4 wt. % to about 30 wt. %, about 5 wt. % to about 30 wt. %, about 8 wt. % to about 30 wt. %, about 10 wt. % to about 30 wt. %, about 15 wt. % to about 30 wt. %, about 20 wt. % to about 30 wt. %, or about 25 wt. % to about 30 wt. % of the peracetic acid-forming mixture.

In such peracetic acid-forming mixture, percarbonate may be used in an amount of about 10 wt. % to about 60 wt. % of the peracetic acid-forming mixture. In some examples, percarbonate may be present in the peracetic acid-forming mixture in a concentration of about 10 wt. % to about 55 wt. %, about 10 wt. % to about 50 wt. %, about 10 wt. % to about 45 wt. %, about 10 wt. % to about 40 wt. %, about 10 wt. % to about 35 wt. %, about 10 wt. % to about 30 wt. %, about 10 wt. % to about 25 wt. %, about 10 wt. % to about 20 wt. %, about 10 wt. % to about 15 wt. %, about 15 wt. % to about 60 wt. %, about 20 wt. % to about 60 wt. %, about 25 wt. % to about 60 wt. %, about 30 wt. % to about 60 wt. %, about 35 wt. % to about 60 wt. %, about 35 wt. % to about 60 wt. %, about 40 wt. % to about 60 wt. %, about 45 wt. % to about 60 wt. %, about 50 wt. % to about 60 wt. %, or about 55 wt. % to about 60 wt. % of the peracetic acid-forming mixture.

In such peracetic acid-forming mixture, carbonate may be used in an amount of about 10 wt. % to about 60 wt. % of the peracetic acid-forming mixture. In some examples, carbonate may be present in the peracetic acid-forming mixture in a concentration of about 10 wt. % to about 55 wt. %, about 10 wt. % to about 50 wt. %, about 10 wt. % to about 45 wt. %, about 10 wt. % to about 40 wt. %, about 10 wt. % to about 35 wt. %, about 10 wt. % to about 30 wt. %, about 10 wt. % to about 25 wt. %, about 10 wt. % to about 20 wt. %, about 10 wt. % to about 15 wt. %, about 15 wt. % to about 60 wt. %, about 20 wt. % to about 60 wt. %, about 25 wt. % to about 60 wt. %, about 30 wt. % to about 60 wt. %, about 35 wt. % to about 60 wt. %, about 40 wt. % to about 60 wt. %, about 45 wt. % to about 60 wt. %, about 50 wt. % to about 60 wt. %, or about 55 wt. % to about 60 wt. % of the peracetic acid-forming mixture.

In such peracetic acid-forming mixture, an acidifying agent may be used in an amount of about 5 wt. % to about 35 wt. % of the peracetic acid-forming mixture. In some examples, the acidifying agent may be present in the peracetic acid-forming mixture in a concentration of about 5 wt. % to about 30 wt. %, about 5 wt. % to about 25 wt. %, about 5 wt. % to about 20 wt. %, about 5 wt. % to about 15 wt. %, about 5 wt. % to about 10 wt. %, about 5 wt. % to about 7 wt. %, about 7 wt. % to about 35 wt. %, about 10 wt. % to about 35 wt. %, about 15 wt. % to about 35 wt. %, about 20 wt. % to about 35 wt. %, about 25 wt. % to about 35 wt. %, or about 30 wt. % to about 35 wt. % of the peracetic acid-forming mixture.

In some examples, the concentration of acidifying agent used is dependent upon the type of acidifying agent used and its protic ability. For example, a triprotic acid is capable of donating three protons, a diprotic acid is capable of donating two protons, and a monoprotic acid is capable of donating one proton. Therefore, the protic nature of the acidifying agent affects the ability of the acidifying agent to act on a compound by donating a proton. In some examples, a lower concentration of a triprotic acidifying may be required because it can donate three protons to a compound, while a higher concentration of a monoprotic may be required because it can donate only one proton.

In some examples, the peracetic acid-forming mixture described herein forms the entirety of the composition (i.e., the composition comprises TAED, percarbonate and/or carbonate, and an acidifying agent). In other examples, the peracetic acid-forming mixture may be a part of the composition that comprises other components that are described herein. In other examples, the composition may not comprise the peracetic acid-forming mixture and may instead comprise other components described herein. The present disclosure contemplates that the compositions may comprise any of the components described herein and may be selected based upon the microbial reduction needs of the ethanol production system.

In some examples, the composition is formulated as a dry powder. This formulation of the composition allows for the composition to remain stable without degradation for long periods of time because there is minimal moisture in the composition in its dry powder form. Additionally, the dry, powdered composition may coat the whole raw material.

As used herein, “coat” and “coating” refer to mixing the whole raw material and the composition such that the whole raw material and the composition are incorporated together. In some examples, a coating can refer to an application of the composition to the whole raw material where the composition does not contact all of the surface of the whole raw material. The composition may contact at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95% of the surface of the whole raw material. In some examples, a coating can refer to an application of the composition to the whole raw material that is uneven, meaning that not all surfaces of the whole raw material encounter the same amount of the composition. In some examples, a coating can refer to layer of composition that covers the whole raw material evenly across all of its surfaces.

When the composition is formulated as a dry powder, there is no need for alcohols, water, and/or solvents in the composition to act as carriers or diluents. In some examples, the composition is free of solvent. In some examples, the composition is free of alcohol. In some examples, the composition is free of solvent, free of water, and free of alcohol. In some examples, the composition is free of both solvent and alcohol. As used herein, a solvent can refer to any non-aqueous liquid.

Additionally, when the composition is formulated as a dry powder, the whole raw material that is coated in the composition can sit for long periods of time in storage without negatively impacting the raw material, such as by molding.

In some examples, the composition is formulated as a liquid, or some of the components of the composition are formulated as a liquid that can be added to powdered components of the composition. For example, if the compositions comprises TAED and peracid, the TAED may be formulated as a powder while the peracid may be formulated as a liquid. In such examples, the components of the composition may be mixed prior to being added to the raw material.

In some examples, the composition may be prepared as a concentrate that can be diluted prior to use. When the composition is prepared as a concentrate, the concentrate may comprise little to no water or other diluent, such as sodium hydroxide. The concentrate maybe diluted with a diluent to form a use solution.

In some examples, the composition may be prepared as a ready-to-use (RTU) formulation that is ready to be applied directly to the raw material without dilution, mixing, or combining any of the components of the composition.

In some examples, different components of the composition may be formulated differently. For example, if the composition comprises a peracid, the peracid may be prepared as a ready-to-use liquid that may be added to a concentrate comprising other components to be used in the composition. The present disclosure contemplates compositions that are formed from a variety of components that may be a concentrate to be diluted or as a ready-to-use formula.

The composition described herein may reduce or eliminate the need for antibiotics in an ethanol production system. In some examples, an ethanol production system in accordance with the compositions and methods described herein is free of antibiotics. In some examples, an ethanol production system in accordance with the compositions and methods described herein uses a reduced concentration of antibiotics.

### Methods of Use for Microbiological Control

The compositions described herein are applied to a whole raw material to control the microbial population on the surface of the whole raw material. As described herein, the composition may be added to the whole raw material as a pre-mixed composition, as separate components, in a stepwise fashion, or combinations thereof.

In some examples, the composition is added to the whole raw material before it undergoes substantial processing, such as grinding or milling. If the composition is added to the whole raw material, the composition can reduce the microbial population on the whole raw material before it is used in ethanol production. This reduces the amount of microbial contamination that is introduced into the ethanol production process.

In some examples, the composition is added to the whole raw material at any point before the whole raw material enters the ethanol production process. For example, the composition may be added to the whole raw material while the whole raw material is at an agricultural site, on a transport vehicle on its way to an ethanol production facility, in a hopper, in a silo, in transport from a hopper or silo to the ethanol production equipment, or combinations thereof.

In some examples, the composition comprising the one or more antimicrobials and the one or more functional agents are added to the whole raw material as a dry powder.

In some examples, the one or more antimicrobials and the one or more functional agents are added separately, each as a dry powder to the whole raw material and are mixed with the whole raw material.

In examples where the composition and its constituents are a dry powder, the composition is added to the whole raw material such that the whole raw material is mixed with the composition and sits in a silo (or other storage container). For example, this mixing may be achieved by incorporating the composition into a hopper with the whole raw material to mix the components together. This may also be achieved by a mixing step that occurs in a silo such that the whole raw material is mixed with the composition while the whole raw material is in the silo.

In some examples, the whole raw material may be mixed with the composition using mechanical agitation such that the outer surface of the whole raw material is coated with the composition.

In some examples, the one or more antimicrobials are gaseous. In such examples, the whole raw material is exposed to the one or more gaseous antimicrobials. The whole raw material may also be mixed with one or more additional antimicrobials and one or more functional agents, before or after exposure to the gaseous antimicrobial(s).

In some examples, the whole raw material that has been mixed with the composition is also exposed to one or more additional gaseous antimicrobials.

The gaseous antimicrobials may comprise ozone, chlorine dioxide, or combinations thereof. In some examples, the whole raw material is exposed to one or more gaseous antimicrobials prior to being coated in the composition. In some examples, the whole raw material is exposed to one or more gaseous antimicrobials after being coated in the composition. For example, the raw material may be coated in the composition and then exposed to gaseous ozone, chlorine dioxide, or both.

Gaseous antimicrobials used herein may be produced onsite at an ethanol production facility. The gaseous antimicrobials may also be produced elsewhere and shipped to an ethanol production facility. In some examples, the gaseous antimicrobials are produced and/or shipped in a gaseous form. In some examples, the gaseous antimicrobials are produced and/or shipped in a liquid form. The liquid form of the gaseous antimicrobials may be diluted, before arriving to the ethanol production facility or at the ethanol production facility, and allowed to transition to gaseous form. In one example, chlorine dioxide may be generated as a gas by passing chlorine gas over dry sodium chlorite.

The gaseous antimicrobials may be used in a concentration of about 0.1 ppm to about 10 ppm relative to the reaction vessel that the gas is added to. The gaseous antimicrobials may be used in a concentration of about 0.1 ppm to about 10 ppm, about 0.1 ppm to about 9 ppm, about 0.1 ppm to about 8 ppm, about 0.1 ppm to about 7 ppm, about 0.1 ppm to about 6 ppm, about 0.1 ppm to about 5 ppm, about 0.1 ppm to about 4 ppm, about 0.1 ppm to about 3 ppm, about 0.1 ppm to about 2 ppm, about 0.1 ppm to about 1 ppm, about 0.1 ppm to about 0.5 ppm, about 0.5 ppm to about 10 ppm, about 1 ppm to about 10 ppm, about 2 ppm to about 10 ppm, about 3 ppm to about 10 ppm, about 4 ppm to about 10 ppm, about 5 ppm to about 10 ppm, about 6 ppm to about 10 ppm, about 7 ppm to about 10 ppm, about 8 ppm to about 10 ppm, or about 9 ppm to about 10 ppm.

In some examples, the concentration of gaseous antimicrobials used as described herein is measured based on various known methods in the art. For example, ozone concentration may be measured in a reaction vessel using ozone-specific sensors and thus will report a concentration in ppm based on the gas content in the air. As another example, chlorine dioxide concentration may be measured in ppm using UV absorbance. Other concentration measurement methods known in the art are contemplated herein. The concentration of the gaseous antimicrobials may be selected depending upon various factors such as the level of microbial populations to address, the size of the reaction mechanism, the type of antimicrobial, the delivery method of the antimicrobial, or the method of measuring the concentration of the antimicrobial.

Once the whole raw material is mixed in the composition and/or exposed to one or more additional antimicrobials or antimicrobial precursors that are gaseous, the whole raw material may sit for a period of time to allow the composition to reduce the microbial population on the whole raw material. In some examples, the whole raw material may sit for a period of about 30 minutes to about 14 days. In some examples, the whole raw material sits for a period of about 30 minutes to about 13 days, about 30 minutes to about 12 days, about 30 minutes to about 11 days, about 30 minutes to about 10 days, about 30 minutes to about 9 days, about 30 minutes to about 8 days, about 30 minutes to about 7 days, about 30 minutes to about 6 days, about 30 minutes to about 5 days, about 30 minutes to about 4 days, about 30 minutes to about 3 days, about 30 minutes to about 2 days, about 30 minutes to about 24 hours, about 30 minutes to about 12 hours, about 30 minutes to about 8 hours, about 30 minutes to about 4 hours, about 30 minutes to about 2 hours, about 30 minutes to about 1 hour, about 1 hour to about 14 days, about 2 hours to about 14 days, about 4 hours to about 14 days, about 8 hours to about 14 days, about 12 hours to about 14 days, about 24 hours to about 14 days, about 2 days to about 14 days, about 3 days to about 14 days, about 4 days to about 14 days, about 5 days to about 14 days, about 6 days to about 14 days, about 7 days to about 14 days, about 8 days to about 14 days, about 9 days to about 14 days, about 10 days to about 14 days, about 11 days to about 14 days, about 12 days to about 14 days, or about 13 days to about 14 days.

The composition acts on the surface of the whole raw material to reduce the microbial population on the surface of the whole raw material. Without wishing to be bound by theory, it is believed that when the composition is in a dry, powdered form and coated on the surface of the whole raw material, humidity from the atmosphere interacts with the coated whole raw material to activate the composition to reduce the microbial population. The humidity from the atmosphere may activate the composition such that the microbial population on the surface of the whole raw material may be reduced.

In some examples, there may be a delay in time between when the composition is applied to the surface of the whole raw material and when the composition is activated. For example, the composition may be applied to the surface of the whole raw material with no activation of the composition for a period of time, after which the composition interacts with humidity and/or liquid and is activated. The period of time may be about 1 minute to about 4 weeks, 5 minutes to about 3 weeks, about 10 minutes to about 2 weeks, about 15 minutes to about 7 days, about 30 minutes to about 6 days, about 1 hour to about 5 days, about 5 hours to about 4 days, about 12 hours to about 3 days, about 24 hours to about 2 days, or about 1 day to about 36 hours.

Once the coated whole raw material has sat for a period of time, the microbial population on the whole raw material has been reduced. In some examples, the microbial population has been reduced by at least 1 log after 1,000 minutes, after 100 minutes, or after 10 minutes.

After the microbial population on the whole raw material has been reduced, the whole raw material may be processed to begin the ethanol production process. For example, this can include grinding or milling the whole raw material which then is used to produce ethanol.

The present disclosure contemplates multiple compositions and methods for reducing microbial growth in ethanol production. Many configurations of compositions and methods are contemplated herein. Some non-limiting exemplary compositions and methods are described below. Other compositions and methods are contemplated in accordance with the details of the present disclosure.

In some examples, the whole raw material may be coated with a composition. The composition may comprise TAED, percarbonate, carbonate, and an acidifying agent. The whole raw material may be mechanically agitated with the composition to coat the outer surface of the whole raw material. The whole raw material coated in the composition may sit for a period of time to allow the composition to interact with atmospheric conditions and form peracetic acid to reduce the microbial population on the whole raw material.

In some examples, the whole raw material may be coated with a composition. The composition may comprise TAED, percarbonate, carbonate, and an acidifying agent. The whole raw material may also be exposed to gaseous ozone before or after being coated in the composition.

In some examples, the whole raw material may be coated with a composition. The composition may comprise TAED, percarbonate, carbonate, and an acidifying agent. The whole raw material may also be exposed to gaseous chlorine dioxide before or after being coated in the composition.

In some examples, the whole raw material may be coated with a composition. The composition may comprise TAED, percarbonate, carbonate, and an acidifying agent. The whole raw material may also be exposed to gaseous chlorine dioxide and ozone before or after being coated in the composition.

In some examples, the whole raw material may be exposed to gaseous ozone.

In some examples, the whole raw material may be exposed to gaseous chlorine dioxide.

In some examples, the whole raw material may be coated with a composition comprising dry, powdered percarbonate.

In some examples, the whole raw material may be coated with a composition comprising dry, powdered percarbonate and an acidifying agent.

In some examples, the whole raw material may be coated with a composition comprising dry, powdered percarbonate and an acidifying agent. The whole raw material may also be exposed to gaseous ozone before or after being coated in the composition.

In some examples, the whole raw material may be coated with a composition comprising dry, powdered percarbonate and an acidifying agent. The whole raw material may also be exposed to gaseous chlorine dioxide before or after being coated in the composition.

In some examples, the whole raw material may be coated with a composition comprising dry, powdered percarbonate and an acidifying agent. The whole raw material may also be exposed to gaseous ozone and chlorine dioxide before or after being coated in the composition.

The following non-limiting Examples are provided as illustrative embodiments of the disclosure. Notwithstanding that the numerical ranges and parameters setting forth the broad scope of the disclosure are approximations, the numerical values set forth in the specific examples are reported as precisely as possible. Any numerical values, however, inherently contain certain errors necessarily resulting from the standard deviation found in their respective testing measurements. The Examples are illustrative and may only show limited numerical quantities of the components described above. Only some Examples are shown for the sake of brevity, but the full quantity ranges of components described above are contemplated.

### EXAMPLES

### Example 1: Evaluating Microbial Reduction

In Example 1, a composition was prepared in accordance with the present disclosure and used to evaluate the efficacy of microbial reduction on whole kernel corn.

The composition comprised 55-60 wt. % of sodium carbonate, 28-32 wt. % of citric acid (as an acidifying agent), 6.38% of sodium carbonate peroxide (also known as sodium percarbonate), 2.55% of TAED, and less than 1% of polyethylene-polypropylene glycol.

An inoculum was prepared to simulate the microbial population that may be present on a harvested whole raw material to be used in ethanol production. The inoculum comprised Lactobacillus brevis, ATCC 14869. The inoculum was prepared by growing the Lactobacillus brevis in MRS broth at 30° C. for 48 hours and diluting the Lactobacillus brevis at a ratio of 1:1 in MRS Broth.

For each trial shown in Table 1, 200 grams of whole kernel corn was placed in a container. The corn was sprayed with about 1 mL of the inoculum. After the corn was sprayed, it was left to dry at room temperature for 30 minutes with occasional mixing to ensure coating of the corn with the inoculum.

After the corn was inoculated, the composition was added to the container in an amount sufficient to impart the desired concentration for each trial shown in Table 1. The concentrations listed in Table 1 reflect the concentration of the composition relative to the weight of the sample of corn to be tested.

The corn and composition were mechanically agitated for 30 seconds to thoroughly mix the corn and the composition. The coated corn was removed from the container and spread in a single layer on an aluminum tray and exposed to 60% relative humidity at 23° C. for the time periods outlined in Table 1. After which, the corn was removed from the humidity chamber and neutralized with 100 mL of DE Broth to prevent further change in the microbial population. The microbial log reduction was then measured for each trial.

Table 1 shows the log reduction of microorganisms on the surface of the whole kernel corn after treatment with the composition, compared to the whole kernel corn that was inoculated and not subject to treatment with the composition.

TABLE 1

| | | Post-Treatment | Log |
|---|---|---|---|
| | % Application | Elapsed Time | Reduction (compared |
| Trial # | (w/w) | (minutes) | to no treatment) |
| 1 | 0.5% | 100 | 0.30 |
| 2 | 0.1% | 100 | 0.14 |
| 3 | 0.05% | 100 | 0.12 |
| 4 | 0.01% | 100 | 0.00 |
| 5 | 0.005% | 100 | 0.00 |
| 6 | 0.5% | 1100 | 1.12 |
| 7 | 0.1% | 1100 | 0.96 |
| 8 | 0.05% | 1100 | 0.88 |
| 9 | 0.01% | 1100 | 0.00 |
| 10 | 0.005% | 1100 | 0.00 |

Trials 1-5 evaluated the microbial reduction using varying concentrations of the composition. The composition remained on the whole kernel corn for 100 minutes before the log reduction of the microbial population was measured.

In trials 6-10, the same concentrations of the composition were tested, but the composition remained on the whole kernel corn for 1100 minutes before the log reduction of the microbial population was measured.

While the composition exhibited microbial reduction on the whole kernel corn after 100 minutes of treatment, whole kernel corn treated for 1100 minutes demonstrated a greater microbial reduction at concentrations above 0.05% of the composition. This suggests that exposing the whole kernel corn (or other whole raw material) to the composition for longer periods of time results in improved microbial reduction, at least with the lower concentrations the composition that were tested in this Example. It is anticipated that higher concentrations of the composition would produce improved microbial reduction in the same, or shorter, time periods.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

Also described herein are aspects:

Aspect 1: A method of reducing a microbial population on a whole raw material for ethanol production, the method comprising: applying a composition to the whole raw material, the composition comprising one or more antimicrobial, wherein the composition is free of solvent or alcohol.

Aspect 2: The method of aspect 1, wherein the whole raw material is selected from the group consisting of corn, rice, nuts, wheat berries, sugar cane, sugar beets, and combinations thereof.

Aspect 3: The method of any one of aspects 1-2, wherein the composition is free of antibiotics.

Aspect 4: The method of any one of aspects 1-3, wherein the one or more antimicrobial is selected from the group consisting of peracetic acid, ozone, chlorine dioxide, nisin, sodium chlorite, hydrogen peroxide, acetic acid, sodium hypochlorite, organic acids, percarbonate, carbonate, and combinations thereof.

Aspect 5: The method of any one of aspects 1-4, wherein the one or more antimicrobial is peracetic acid.

Aspect 6: The method of aspect 5, wherein the peracetic acid is formed from a reaction comprising TAED, percarbonate, carbonate, and an acidifying agent.

Aspect 7: The method of aspect 6, wherein the acidifying agent is selected from the group consisting of citric acid, 2-hydroxypropane-1,2,3-tricarboxylic acid, sodium bisulfate, tartaric acid, malic acid, fumaric acid, lactic acid, and combinations thereof.

Aspect 8: The method of any one of aspects 1-7, wherein applying the composition to the whole raw material exposes the whole raw material to the composition for a period of time.

Aspect 9: The method of aspect 8, wherein the period of time is at least 30 minutes.

Aspect 10: The method of aspect 8, wherein the period of time is at least 4 hours.

Aspect 11: The method of aspect 8, wherein the period of time is at least 12 hours.

Aspect 12: The method of aspect 8, wherein the period of time is at least 24 hours.

Aspect 13: The method of aspect 8, wherein the period of time is at least 3 days.

Aspect 14: The method of aspect 8, wherein the period of time is at least 1 week.

Aspect 15: The method of aspect 8, wherein the period of time is 1 day to 14 days.

Aspect 16: The method of any one of aspects 1-15, wherein the composition is a dry powder.

Aspect 17: The method of any one of aspects 1-16, wherein the one or more antimicrobial is a dry powder.

Aspect 18: The method of any one of aspects 1-17, wherein the one or more antimicrobial is in a gaseous form.

Aspect 19: The method of aspect 17, wherein applying the composition to the whole raw material coats the outer surface of the whole raw material with the composition.

Aspect 20: The method of any one of aspects 1-19, further comprising the step of agitating the raw material and the composition such that the outer surface of the whole raw material is exposed to the composition.

Aspect 21: The method of any one of aspects 1-20, further comprising the step of exposing the whole raw material to gaseous chlorine dioxide.

Aspect 22: The method of any one of aspects 1-21, further comprising the step of exposing the whole raw material to gaseous ozone.

Aspect 23: The method of any one of aspects 1-22, wherein the composition comprises about 0.1 ppm to about 50 ppm of the one or more antimicrobial.

Aspect 24 The method of aspect 6, wherein TAED, percarbonate, carbonate, and the acidifying agent form a peracetic acid-forming mixture that is applied to the whole raw material.

Aspect 25: The method of aspect 24, wherein the peracetic acid-forming mixture comprises about 0.5 wt. % to about 25 wt. % of TAED.

Aspect 26: The method of any one of aspects 24-25, wherein the peracetic acid-forming mixture comprises about 10 wt. % to about 60 wt. % of percarbonate.

Aspect 27: The method of any one of aspects 24-26, wherein the peracetic acid-forming mixture comprises about 10 wt. % to about 60 wt. % of carbonate.

Aspect 28: The method of any one of aspects 24-27, wherein the peracetic acid-forming mixture comprises about 5 wt. % to about 35 wt. % of the acidifying agent.

Aspect 29: The method of any one of aspects 1-28, wherein the composition comprises one or more functional agents selected from the group consisting of polymers, binders, fillers, anti-caking agents, desiccating agents, stabilizers, preservatives, chelating agents, sequestrants, and combinations thereof.

Aspect 30: A method of reducing a microbial population on a whole raw material for ethanol production, the method comprising: applying a dry powdered composition to the whole raw material, the composition comprising a peracetic acid-forming mixture comprising TAED, percarbonate, carbonate, and an acidifying agent; mixing the dry powdered composition and the whole raw material to form a coated whole raw material; and exposing the coated whole raw material to atmospheric conditions for a period of time, wherein the composition is free of solvent or alcohol.

Aspect 31: The method of aspect 30, wherein the period of time is at least 30 minutes.

Aspect 32: The method of aspect 30, wherein the period of time is at least 4 hours.

Aspect 33: The method of aspect 30, wherein the period of time is at least 12 hours.

Aspect 34: The method of aspect 30, wherein the period of time is at least 24 hours.

Aspect 35: The method of aspect 30, wherein the period of time is at least 3 days.

Aspect 36: The method of aspect 30, wherein the period of time is at least 1 week.

Aspect 37: The method of aspect 30, wherein the period of time is 1 day to 14 days.

Aspect 38: The method of any one of aspects 30-37, wherein the mixing step comprises mechanical agitation of the dry powdered composition and the whole raw material.

Aspect 39: The method of any one of aspects 30-38, further comprising exposing the coated whole raw material to gaseous chlorine dioxide.

Aspect 40: The method of any one of aspects 30-39, further comprising exposing the coated whole raw material to gaseous ozone.

Aspect 41 The method of any one of aspects 30-40, wherein the acidifying agent is selected from the group consisting of citric acid, 2-hydroxypropane-1,2,3-tricarboxylic acid, sodium bisulfate, tartaric acid, malic acid, fumaric acid, lactic acid, and combinations thereof.

Aspect 42: The method of any one of aspects 30-41, wherein the whole raw material is not treated with antibiotics.

Aspect 43: The method of any one of aspects 30-42, wherein the whole raw material is selected from the group consisting of corn, rice, nuts, wheat berries, sugar cane, sugar beets, and combinations thereof.

Aspect 44: The method of any one of aspects 30-43, wherein the composition further comprises one or more functional agents selected from the group consisting of polymers, binders, fillers, anti-caking agents, desiccating agents, stabilizers, preservatives, chelating agents, sequestrants, and combinations thereof.

Aspect 45: The method of any one of aspects 30-44, wherein the peracetic acid-forming mixture comprises about 0.5 wt. % to about 25 wt. % of TAED.

Aspect 46: The method of any one of aspects 30-45, wherein the peracetic acid-forming mixture comprises about 10 wt. % to about 60 wt. % of percarbonate.

Aspect 47: The method of any one of aspects 30-46, wherein the peracetic acid-forming mixture comprises about 10 wt. % to about 60 wt. % of carbonate.

Aspect 48: The method of any one of aspects 30-47, wherein the peracetic acid-forming mixture comprises about 5 wt. % to about 35 wt. % of the acidifying agent.

What is claimed is:

1. A method of reducing a microbial population on a whole raw material for ethanol production, the method comprising:
applying a composition to the whole raw material, the composition comprising one or more antimicrobial,
wherein the composition is free of solvent or alcohol.

2. The method of claim 1, wherein the whole raw material is selected from the group consisting of corn, rice, nuts, wheat berries, sugar cane, sugar beets, and combinations thereof.

3. The method of claim 1, wherein the composition is free of antibiotics.

4. The method of claim 1, wherein the one or more antimicrobial is selected from the group consisting of peracetic acid, ozone, chlorine dioxide, nisin, sodium chlorite, hydrogen peroxide, acetic acid, sodium hypochlorite, organic acids, percarbonate, carbonate, and combinations thereof.

5. The method of claim 4, wherein the peracetic acid is formed from a reaction comprising TAED, percarbonate, carbonate, and an acidifying agent.

6. The method of claim 5, wherein the acidifying agent is selected from the group consisting of citric acid, 2-hydroxypropane-1,2,3-tricarboxylic acid, sodium bisulfate, tartaric acid, malic acid, fumaric acid, lactic acid, and combinations thereof.

7. The method of claim 1, wherein applying the composition to the whole raw material exposes the whole raw material to the composition for a period of time.

8. The method of claim 7, wherein the period of time is at least 30 minutes.

9. The method of claim 1, wherein the composition is a dry powder.

10. The method of claim 1, wherein applying the composition to the whole raw material coats the outer surface of the whole raw material with the composition.

11. The method of claim 1, wherein the composition comprises about 0.1 ppm to about 50 ppm of the one or more antimicrobial.

12. The method of claim 4, wherein TAED, percarbonate, carbonate, and the acidifying agent form a peracetic acid-forming mixture that is applied to the whole raw material.

13. The method of claim 1, wherein the composition comprises one or more functional agents selected from the group consisting of polymers, binders, fillers, anti-caking agents, desiccating agents, stabilizers, preservatives, chelating agents, sequestrants, and combinations thereof.

14. A method of reducing a microbial population on a whole raw material for ethanol production, the method comprising:
applying a dry powdered composition to the whole raw material, the composition comprising a peracetic acid-forming mixture comprising TAED, percarbonate, carbonate, and an acidifying agent;
mixing the dry powdered composition and the whole raw material to form a coated whole raw material; and
exposing the coated whole raw material to atmospheric conditions for a period of time,
wherein the composition is free of solvent or alcohol.

15. The method of claim 14, wherein the period of time is at least 30 minutes.

16. The method of claim 14, wherein the mixing step comprises mechanical agitation of the dry powdered composition and the whole raw material.

17. The method of claim 14, wherein the acidifying agent is selected from the group consisting of citric acid, 2-hydroxypropane-1,2,3-tricarboxylic acid, sodium bisulfate, tartaric acid, malic acid, fumaric acid, lactic acid, and combinations thereof.

18. The method of claim 14, wherein the whole raw material is not treated with antibiotics.

19. The method of claim 14, wherein the whole raw material is selected from the group consisting of corn, rice, nuts, wheat berries, sugar cane, sugar beets, and combinations thereof.

20. The method of claim 14, wherein the composition further comprises one or more functional agents selected from the group consisting of polymers, binders, fillers, anti-caking agents, desiccating agents, stabilizers, preservatives, chelating agents, sequestrants, and combinations thereof.
